(19) United States
(12) Patent Application Publication
(10) Pub. No.: US 2014/0062633 A1
(43) Pub. Date: Mar. 6, 2014

(54) COIL COMPONENT

(71) Applicant: SAMSUNG ELECTRO-MECHANICS CO., LTD., Gyeonggi-do (KR)

(72) Inventors: Won Chul Sim, Gyeonggi-do (KR); Sung Kwon Wi, Gyeonggi-do (KR); Young Ghyu Ahn, Gyeonggi-do (KR); Young Seuck Yoo, Gyeonggi-do (KR)

(73) Assignee: SAMSUNG ELECTRO-MECHANICS CO., LTD., Gyeonggi-do (KR)

(21) Appl. No.: 13/794,687

(22) Filed: Mar. 11, 2013

(30) Foreign Application Priority Data
Aug. 29, 2012 (KR) 10-2012-0094777

(51) Int. Cl. H01F 21/12

(52) U.S. Cl. CPC H01F 21/12
USPC 336/20

(57) ABSTRACT

Disclosed herein is a coil component including: an electrode structure made of an insulating material and including at least two internal electrodes vertically disposed therein in a height direction and having a coil shape; and external electrode terminals provided on an upper surface of the electrode structure, wherein a vertical distance (d3) between the internal electrodes is larger than a horizontal distance (d1) between the internal electrodes, in order to secure impedance capacity of a predetermined level and increase a cut-off frequency.

### CROSS REFERENCE(S) TO RELATED APPLICATIONS

This application claims the benefit under 35 U.S.C. Section 119 of Korean Patent Application Serial No. 10-2012-0094777, entitled “Coil Component” filed on Aug. 29, 2012, which is hereby incorporated by reference in its entirety into this application.

### BACKGROUND OF THE INVENTION

1. Technical Field

The present invention relates to a coil component, and more particularly, to a coil component in which a distance between electrodes is adjusted.

2. Description of the Related Art

In accordance with the development of a technology, electronic devices such as a portable phone, a home appliance, a personal computer (PC), a personal digital assistant (PDA), a liquid crystal display (LCD), and the like, have been changed from an analog scheme into a digital scheme and have been speeded up due to an increase in a processed data amount.

However, the digitized and speeded up electronic devices are sensitive to stimulus from the outside. That is, in the case in which small abnormal voltage and a high frequency noise are introduced from the outside into an internal circuit of the electronic device, a circuit may be damaged and a signal may be distorted. Here, as causes of the abnormal voltage and the noise that generate the damage of the circuit of the electronic device and the distortion of the signal, there are a thunderbolt, electrostatic discharge charged with electricity in a human body, switching voltage generated in the circuit, a power noise included in power supply voltage, an unnecessary electromagnetic signal, electromagnetic noise, or the like.

In order to prevent the damage of the circuit and the electronic device and the distortion of the signal, a filter should be installed to prevent the abnormal voltage and the noise from being introduced into the circuit. In order to remove a common mode noise, a common mode filter is generally used in a high speed differential line, or the like.

The common mode noise is noise generated in the differential line, and the common mode filter removes noises that may not be removed by an existing electromagnetic interference (EMI) filter. The common mode filter contributes to improvement in EMI characteristics of a home appliance, or the like, and improvement of antenna characteristics of a cellular phone, or the like.

There are mainly three requirements for the common mode filter. A first requirement of the common mode filter is miniaturization and slimness. For example, the common mode filter needs to have a size of about 0.8 mm×0.6 mm×0.4 mm (0806 specification), 0.6 mm×0.5 mm×0.3 mm (0605 specification). A second requirement of the common mode filter is that common mode impedance is maintained at about 30 to 100Ω and differential mode impedance is maintained at about at most 15Ω, in a low frequency band of about 100 MHz. A third requirement is that IR characteristics are maintained at 10 MΩ or more and a cut-off frequency band is maintained at 2 GHz or more. As the common mode filter is recently used in a mobile device, it has been miniaturized and thinned in view of a size and has required a cut-off frequency of 7 GHz or more in order to correspond to a signal line of USB3.0.

Particularly, in order to increase the cut-off frequency (FC), in Japanese Patent Laid-Open Publication No. 2008-252121 (hereinafter, referred to as Related Art Document), a common mode filter having first and second coil conductors is configured so that a width (W) and a length (L) of at least one of the first and second coil conductors satisfies the following relationship: √(L/W)<(7.6651-fc)/0.1385.

Meanwhile, in order to secure a predetermined impedance capacity of the common mode filter, it is required to increase turns of the coil to allow a length of the coil to become a predetermined length or more. However, in the case of increasing the width (W) of the coil conductor according to an experimental equation derived in Related Art Document in order to increase the cut-off frequency, a chip area increases, such that it is difficult to miniaturize the common mode filter. Therefore, the development of a coil component capable of securing impedance capacity of a predetermined level or more and increasing a cut-off frequency, while allowing a common mode filter to be miniaturized has been urgently demanded.

### RELATED ART DOCUMENT

### Patent Document

(Patent Document 1) Japanese Patent Laid-open Publication No. 2008-252121

### SUMMARY OF THE INVENTION

An object of the present invention is to provide a coil component in which a horizontal distance between internal electrodes, a vertical distance between the internal electrode and an external electrode terminal, and a vertical distance between the internal electrodes are adjusted.

According to an exemplary embodiment of the present invention, there is provided a coil component including: an electrode structure made of an insulating material and including at least two internal electrodes vertically disposed therein in a height direction and having a coil shape; and external electrode terminals provided on an upper surface of the electrode structure, wherein a vertical distance (d3) between the internal electrodes is larger than a horizontal distance (d1) between the internal electrodes.

The vertical distance (d3) between the internal electrodes may be in a range of 1 to 3.5 times of the horizontal distance (d1) between the internal electrodes.

The coil component may be a thin film type coil component in which the electrode structure is formed on a magnetic substrate by a thin film process.

The coil component may further include a magnetic composite made of a magnetic powder and a polymer and provided on the upper surface of the electrode structure.

According to another exemplary embodiment of the present invention, there is provided a coil component including: an electrode structure made of an insulating material and including internal electrodes vertically disposed therein and having a coil shape; external electrode terminals provided on an upper surface of the electrode structure, wherein a vertical distance (d2) between the internal electrode and the external electrode terminal is larger than a horizontal distance (d1) between the internal electrodes.

The vertical distance (d2) between the internal electrode and the external electrode terminal may be in a range of 1 to 3 times of the horizontal distance (d1) between the internal electrodes.

At least two internal electrodes may be vertically disposed in a height direction.

A vertical distance (d3) between the internal electrodes may be larger than a horizontal distance (d1) between the internal electrodes.

The vertical distance (d3) between the internal electrodes may be in a range of 1 to 3.5 times of the horizontal distance (d1) between the internal electrodes.

### BRIEF DESCRIPTION OF THE DRAWINGS

FIG. 1 is a perspective view of an appearance of a coil component according to an exemplary embodiment of the present invention;

FIG. 2 is a cross-sectional view taken along the line I-I′ of FIG. 1;

FIG. 3 is a cross-sectional view of a coil component according to another exemplary embodiment of the present invention; and

FIG. 4 is a cross-sectional view of a coil component according to still another exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art. Like reference numerals throughout the description denote like elements.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

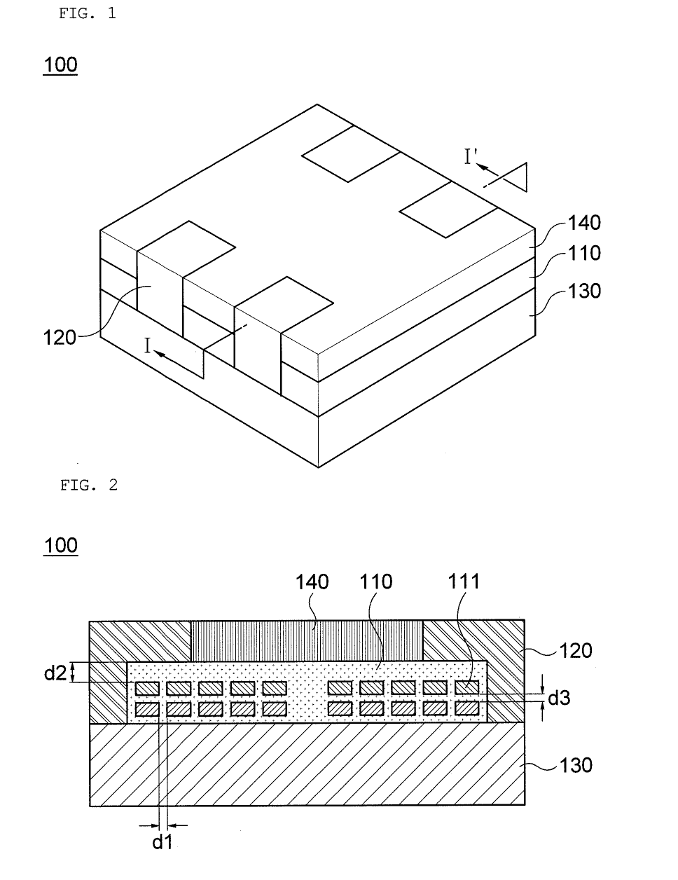

FIG. 1 is a perspective view of an appearance of a coil component according to an exemplary embodiment of the present invention; and FIG. 2 is a cross-sectional view taken along the line I-I′ of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention.

Referring to FIGS. 1 and 2, the coil component 100 according to the exemplary embodiment of the present invention may be configured to include an electrode structure 110 made of a non-magnetic insulating material and including internal electrodes 111 disposed therein and external electrode terminals 120 provided on an upper surface of the electrode structure 110.

Here, the electrode structure 110 may be formed by performing a thin film process on a magnetic substrate 130. Therefore, the coil component 100 according to the exemplary embodiment of the present invention may be a thin film type coil component in which the electrode structure 110 is formed on one surface of the magnetic substrate 130.

A magnetic composite 140 may be provided on the electrode structure 110. The magnetic composite 140 may be formed by a combination of a magnetic powder and one of polyimide, an epoxy resin, benzocyclobutene (BCB), or other polymer. Here, as the magnetic powder, a magnetic material such as ferrite, an Ni based magnetic material, an Ni—Zn based magnetic material, an Ni—Zn—Cu based magnetic material may be used.

The electrode structure 110 may be made of a non-magnetic insulating material including at least one of polyimide, an epoxy resin, benzocyclobutene (BCB), and other polymer. Therefore, as shown in FIG. 1, the electrode structure 110 having low magnetic permeability is provided between the magnetic substrate 130 and the magnetic composite 140 that have relatively high magnetic permeability, such that common mode impedance is implemented without hindering formation of a main magnetic flux loop by the internal electrodes 111.

The external electrode terminal 120, which is a land grid array (LGA) type external electrode terminal, may be bonded to the upper surface of the electrode structure 110. Alternatively, the external electrode terminal 120, which is an L type external electrode terminal, may be bonded to a side of the electrode structure 110 and an end portion of the upper surface of the electrode structure connected to the side. In FIGS. 1 and 2, the L type external electrode terminal 120 is shown.

An insulating material is filled between the external electrode terminal 120 and the internal electrodes 111 in order to electrically insulate therebetween. Therefore, the external electrode terminal 120 positioned on the upper surface of the electrode structure 110 and the internal electrodes 111 are spaced apart from each other by predetermined distance d2, having the insulating material therebetween.

The internal electrodes 111 have a coil pattern shape. Therefore, the internal electrodes 111 are patterned, having a predetermined horizontal distance d1 therebetween. The internal electrodes 111 as described above may be configured in plural and vertically disposed in a height direction, as shown in FIG. 2.

The internal electrodes 111 may be patterned by a thin film process such as a thin film metal deposition process, a lithograph process, an electroplating process, and include at least one of silver (Ag), palladium (Pd), aluminum (Al), chromium (Cr), nickel (Ni), titanium (Ti), gold (Au), copper (Cu), and platinum (Pt) having excellent conductivity.

In addition, although not shown in FIGS. 1 and 2 in order to make the gist of the present invention obvious, the internal electrode 111 forming one coil shape has one end directly connected to an exposed electrode (not shown) formed to be exposed at a side portion of the electrode structure 110 and the other end connected to another exposed electrode through a via (not shown), such that it is electrically connected to the external electrode terminal 120 through the exposed electrodes (not shown).

Meanwhile, in order to obtain predetermined impedance capacity or more, turns of coils of the internal electrodes 111 need to be increased. However, when the turns of the coils are increased, the horizontal distance d1 between the internal electrodes 111 is decreased due to spatial constraints. In this case, parasitic capacitance C1 generated between the internal electrodes is increased, such that insertion loss characteristics of the coil may be deteriorated.

Therefore, the coil component 100 according to the exemplary embodiment of the present invention is characterized in that a vertical distance d2 between the internal electrode 111 and the external electrode terminal 120 is larger than the horizontal distance d1 between the internal electrodes.

More specifically, the vertical distance d2 between the internal electrode 111 and the external electrode terminal 120 is adjusted and formed to be in a range of 1 to 3 times of the horizontal distance d1 between the internal electrodes. When the vertical distance d2 between the internal electrode 111 and the external electrode terminal 120 is excessively increased, impedance capacity of the coil may be decreased. Therefore, it is preferable that the vertical distance d2 between the internal electrode 111 and the external electrode terminal 120 has an appropriate value in the above-mentioned range in consideration of this point.

The following Table 1 shows simulation result values for cut-off frequencies (fc) according to the vertical distance d2 between the internal electrode 111 and the external electrode terminal 120. Here, the horizontal distance d1 between the internal electrodes has been fixed to 5 μm, and impedance of the coil component is 90Ω.

TABLE 1

| | | CUT-OFF |
|---|---|---|
| d2/d1 | CM IMPEDANCE [Ω] | FREQUENCY [GHz] |
| 0.5 | 102.4 | 1.84 |
| 1 | 92.7 | 2.61 |
| 1.5 | 86.3 | 2.79 |
| 2 | 79.5 | 3.12 |
| 2.5 | 70.8 | 3.34 |
| 3 | 58.1 | 3.46 |

Referring to Table 1, it could be appreciated that in the case in which the horizontal distance d1 between the internal electrodes and the vertical distance d2 between the internal electrode 111 and the external electrode terminal 120 are the same as each other, the cut-off frequency (fc) is 2.61 GHz, which is equal to or larger than 2.0 GHz corresponding to a generally required cut-off frequency; however, in the case in which the vertical distance d2 between the internal electrode 111 and the external electrode terminal 120 is configured to be 2 times of the horizontal distance d1 between the internal electrodes, the cut-off frequency (fc) is 3.12 GHz, and in the case in which the vertical distance d2 between the internal electrode 111 and the external electrode terminal 120 is configured to be 3 times of the horizontal distance d1 between the internal electrodes, the cut-off frequency (fc) is 3.46 GHz. However, in this case, the impedance of the coil has been rapidly decreased.

As described above, in the case of increasing the vertical distance d2 between the internal electrode 111 and the external electrode terminal 120 in the state in which the vertical distance d2 between the internal electrode 111 and the external electrode terminal 120 is larger than the horizontal distance d1 between the internal electrodes, parasitic capacitance (C2) generated between the internal electrode 111 and the external electrode terminal 120 is decreased. Therefore, insertion loss characteristics of the coil are improved, such that the cut-off frequency (fc) is increased.

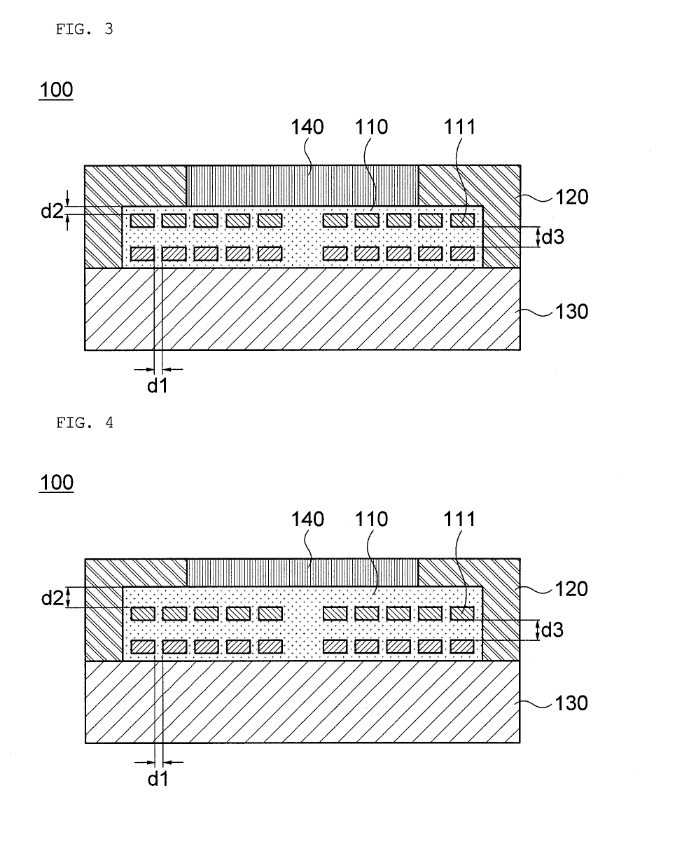

FIG. 3 is a cross-sectional view of a coil component according to another exemplary embodiment of the present invention. In FIG. 3, the same reference numerals as those of FIGS. 1 and 2 will be used to describe the same components.

Referring to FIG. 3, the coil component according to another exemplary embodiment of the present invention may be configured to include an electrode structure 110 formed on one surface of a magnetic substrate 120 by a thin film process and L type external electrode terminals 120 bonded to sides and portions of an upper surface of the electrode structure 110, similar to FIG. 2. A magnetic composite 140 may be provided on the electrode structure 110.

The electrode structure 110 is made of a non-magnetic insulating material and includes at least two internal electrodes 111 vertically disposed therein in a height direction. FIG. 3 illustrates that two internal electrodes 111 are disposed. Therefore, hereinafter, an effect of the present invention will be described on the assumption that the number of internal electrodes 111 is two. However, in the case in which the number of internal electrodes 111 is three or more, it will be obvious that the effect of the present invention is generated corresponding to the case in which the number of internal electrodes 111 is two.

The internal electrodes 111 have a coil pattern shape. Therefore, the internal electrodes 111 are patterned, having a predetermined horizontal distance d1 therebetween. Further, similar to FIG. 2, the internal electrodes 111 each forming one coil are electrically connected to the external electrode terminals 120 through a via (not shown) and an exposed electrode (not shown).

An insulating material is filled between the two internal electrodes 111 in order to electrically insulate therebetween. Therefore, the two internal electrodes 111 are disposed to be spaced apart from each other by a predetermined vertical distance d3 and face each other, having the insulating material therebetween. The two internal electrodes 111 disposed to face each other as described above are electromagnetically coupled to each other, such that they are operated as a common mode filter having large impedance with respect to a common mode component of a current (signal) flowing in the internal electrodes 111 and removing a noise of the common mode component.

Similar to FIG. 2, in order to obtain predetermined impedance capacity or more, turns of coils of the internal electrodes 111 need to be increased. However, when the turns of the coils are increased, the horizontal distance d1 between the internal electrodes 111 is decreased due to spatial constraints. In this case, parasitic capacitance C1 generated between the internal electrodes is increased, such that insertion loss characteristics of the coil may be deteriorated.

Therefore, the coil component according to another exemplary embodiment of the present invention is characterized in that the vertical distance d3 between the internal electrodes 111 is larger than the horizontal distance d1 between the internal electrodes.

More specifically, the vertical distance d3 between the internal electrodes 111 is adjusted and formed to be in a range of 1 to 3.5 times of the horizontal distance d1 between the internal electrodes. When the vertical distance d3 between the internal electrodes 111 is excessively increased, impedance capacity of the coil may be decreased. Therefore, it is preferable that the vertical distance d3 between the internal electrodes 111 has an appropriate value in the above-mentioned range in consideration of this point.

The following Table 2 shows simulation result values for cut-off frequencies (fc) according to the vertical distance d3 between the internal electrodes 111. Here, the horizontal distance d1 between the internal electrodes and the vertical distance (d2) between the internal electrode 111 and the external electrode terminal 120 have been fixed to 5 μm, and impedance of the coil component is 90Ω.

TABLE 2

| | | CUT-OFF |
|---|---|---|
| d3/d1 | CM IMPEDANCE [Ω] | FREQUENCY [GHz] |
| 0.6 | 121.5 | 1.76 |
| 0.8 | 113.5 | 1.93 |
| 1 | 102.4 | 2.61 |
| 1.5 | 96.5 | 3.12 |
| 2 | 92.7 | 3.66 |
| 2.5 | 88.4 | 4.22 |
| 3 | 78 | 4.39 |
| 3.5 | 59 | 5.12 |
| 4 | 43 | 5.37 |

Referring to Table 2, it could be appreciated that in the case in which the horizontal distance d1 between the internal electrodes and the vertical distance d3 between the internal electrodes 111 are the same as each other, the cut-off frequency (fc) is 2.61 GHz, which is equal to or larger than 2.0 GHz corresponding to a generally required cut-off frequency; however, in the case in which the vertical distance d3 between the internal electrodes 111 is configured to be 10 p m corresponding to 2 times of the horizontal distance d1 between the internal electrodes, the cut-off frequency (fc) is 3.66 GHz, and in the case in which the vertical distance d3 between the internal electrodes 111 is configured to be 3 times of the horizontal distance d1 between the internal electrodes, the cut-off frequency (fc) is 4.39 GHz.

On the other hand, when the vertical distance d3 between the internal electrodes 111 is configured to be 3.5 times of the horizontal distance d1 between the internal electrodes, the cut-off frequency has been increased; however, the impedance of the coil has been rapidly decreased.

As described above, in the case of increasing the vertical distance d3 between the internal electrodes 111 in the state in which the vertical distance d3 between the internal electrodes 111 is larger than the horizontal distance d1 between the internal electrodes, parasitic capacitance (C3) generated between the two internal electrodes 111 is decreased. Therefore, insertion loss characteristics of the coil are improved, such that the cut-off frequency (fc) is increased.

FIG. 4 is a cross-sectional view of a coil component according to still another exemplary embodiment of the present invention.

Referring to FIG. 4, the coil component according to still another exemplary embodiment of the present invention is characterized in that the vertical distance d2 between the internal electrode 111 and the external electrode terminal 120 and the vertical distance d3 between the internal electrodes 111 are larger than the horizontal distance d1 between the internal electrodes.

More specifically, the vertical distance d2 between the internal electrode 111 and the external electrode terminal 120 is configured to be in a range of 1 to 3 times of the horizontal distance d1 between the internal electrodes, and the vertical distance d3 between the internal electrodes 111 is configured to be in a range of 1 to 3.5 times of the horizontal distance d1 between the internal electrodes 111.

A total of parasitic capacitance (Ct) generated due to the plurality of internal electrodes 111 and the external electrode terminal 120 spaced apart from each other by a predetermined distance in the coil component becomes C1+C2+C3 according to a parallel structure of parasitic capacitance (C1) generated between the internal electrodes, parasitic capacitance (C2) generated between the internal electrode 111 and the external electrode terminal 120, and parasitic capacitance (C3) generated between the plurality of internal electrodes 111.

Therefore, in the case in which the coil component is configured as shown in FIG. 4, since the effects of improving the cut-off frequency (fc) appearing in each of the components of FIGS. 2 and 3 described above are overlapped with each other, the coil component according to still another exemplary embodiment of the present invention may implement a higher cut-frequency (fc).

With the coil component according to the exemplary embodiments of the present invention, the horizontal distance between the internal electrodes, the vertical distance between the internal electrode and the external electrode terminal, and the vertical distance between the internal electrodes are adjusted, thereby making it possible to secure impedance capacity of a predetermined level and increase the cut-off frequency by removing the parasitic capacitance, in a miniaturized and slimmed coil component.

The above detailed description has illustrated the present invention. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A coil component comprising:
an electrode structure made of an insulating material and including at least two internal electrodes vertically disposed therein in a height direction and having a coil shape; and
external electrode terminals provided on an upper surface of the electrode structure,
wherein a vertical distance (d3) between the internal electrodes is larger than a horizontal distance (d1) between the internal electrodes.

2. The coil component according to claim 1, wherein the vertical distance (d3) between the internal electrodes is in a range of 1 to 3.5 times of the horizontal distance (d1) between the internal electrodes.

3. The coil component according to claim 1, wherein it is a thin film type coil component in which the electrode structure is formed on a magnetic substrate by a thin film process.

4. The coil component according to claim 1, further comprising a magnetic composite made of a magnetic powder and a polymer and provided on the upper surface of the electrode structure.

5. A coil component comprising:
an electrode structure made of an insulating material and including internal electrodes vertically disposed therein and having a coil shape;
external electrode terminals provided on an upper surface of the electrode structure,
wherein a vertical distance (d2) between the internal electrode and the external electrode terminal is larger than a horizontal distance (d1) between the internal electrodes.

6. The coil component according to claim 5, wherein the vertical distance (d2) between the internal electrode and the external electrode terminal is in a range of 1 to 3 times of the horizontal distance (d1) between the internal electrodes.

7. The coil component according to claim 5, wherein at least two internal electrodes are vertically disposed in a height direction.

8. The coil component according to claim 7, wherein a vertical distance (d3) between the internal electrodes is larger than a horizontal distance (d1) between the internal electrodes.

9. The coil component according to claim 8, wherein the vertical distance (d3) between the internal electrodes is in a range of 1 to 3.5 times of the horizontal distance (d1) between the internal electrodes.
